(19) United States
(12) Patent Application Publication
(10) Pub. No.: US 2004/0217000 A1
(43) Pub. Date: Nov. 4, 2004

(54) Gas sensor element and manufacturing the same

(75) Inventors: Takashi Yamamoto, Chiryu-shi (JP); Tomio Sugiyama, Nagoya (JP); Takehito Kimata, Kariya-shi (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref. (JP)

(21) Appl. No.: 10/806,387

(22) Filed: Mar. 23, 2004

(30) Foreign Application Priority Data
Dec. 11, 2003 (JP) 2003-413763
Mar. 24, 2003 (JP) 2003-80884

(51) Int. Cl. G01N 27/26

(52) U.S. Cl. 204/424; 204/426; 29/592.1

(57) ABSTRACT

In a gas sensor element, a sensor portion has a solid electrolyte member and a pair of electrodes. The solid electrolyte member has first and second surfaces opposite thereto. The first and second electrodes are mounted on the first and second surfaces of the solid electrolyte member, respectively. A heater member has a heating element and one and other surfaces opposite thereto. The sensor portion is integrally laminated on the one surface of the heater member. The other surface of the heater member is contactable to the target gas. At least a part of the other surface of the heater member has a ten points average roughness that is no more than 1.71 μm.

### BACKGROUND OF THE INVENTION

The present invention relates to a gas sensor element integrated with a heater.

A gas sensor is recently employed in an automobile internal-combustion engine or other similar devices and applied for measuring a specified gas component, such as oxide or other similar gases contained in an exhaust gas. In order to reduce emissions of the engine immediately after starting of the engine, extremely early activation is required in the gas sensor.

This requirement needs to downsize a gas sensor element integrated in the gas sensor to reduce the heat capacity of the gas sensor element.

In this regard, in a conventional cup-shaped gas sensor, the heater is separated from the gas sensor body of the cup-shaped gas sensor so that the cup-shaped gas sensor has a limitation of its downsizing. Laminated gas sensors each integrating with a heater have been developed.

Such a laminated gas sensor is provided with a plurality of ceramic plates that are laminated on each other. That is, the laminated gas sensor includes electrochemical cells each having a sensor body. The sensor body is composed of a pair of electrodes and a solid electrolyte member with both surfaces on which the paired electrodes are mounted, respectively. The laminated gas sensor also includes a heater on which the sensor body is mounted to be integrally laminated. The heater is composed of a heater substrate where a heating element, energization of which can generate heat, is formed.

In order to control the engine with high accuracy, the above laminated gas sensor has been disposed to the rare side of a catalyst disposed in the exhaust pipe, which is muffler of the engine. In other words, the laminated gas sensor is disposed to the downstream side of the muffler through which the exhausted gas passing through the catalyst flows out.

The downstream side of the catalyst, however, is one of the places susceptible to water in the muffler, and the laminated gas sensor element has a weak mechanical strength as compared with that of the cup-shaped gas sensor element. This results in that, when drops of the water adhere on the surfaces of the laminated gas sensor element, the adhered drops of water may cause water cracks in the surfaces thereof.

As conventional measures for avoiding the water cracks against the laminated gas sensor, the following two particular measures are known to:

mount at least one porous protection layer on at least one of the surfaces of the laminated gas sensor element in part of at least one of the interfaces between the laminated ceramic plates being exposed, thereby reinforcing it

mount a porous protection layer on the outer peripheral surface of the laminated gas sensor element to cover it so as to avoid adherences of poisonous materials to the electrodes, and mount a water-shedding film on the porous protection layer to repel the drops of water

The former measure is disclosed in Japanese Patent Publication No. 2001-281210, and the latter disclosed in Japanese Patent Publication No. H10-170474.

In the former measure, however, in cases where the drops of water adhere on the porous protection layer, the adhered drops of water are apt to be introduced in the porous protection layer. When, therefore, the adhered drops of water are once introduced in the porous protection layer, the introduced drops of water are diffused in the porous protection layer to reach the ceramic plates and/or the heater substrate.

In cases where the drops of water reach the ceramic plates and/or the heater substrate, the parts of them to which the drops of water are adhered may be cooled to shrink. The shrinks of the parts of the ceramic plates and/or the heater substrate may cause tensile stress around them. The tensile stress may be large at the high operation temperature of the gas sensor element, and, especially, it may be largest at the heater substrate at which the operation temperature is highest.

The wider the water-drop adhered areas of the parts of the ceramic plates and/or the heater substrate may be, the larger the absolute amount of shrinkage thereof may be, so that the tensile stress around the water-drop adhered areas may increase with the absolute amount of the shrinkage being large. In cases where the tensile stress may reach not less than the material strength of the heater substrate, the tensile stress may cause the gas sensor element to deteriorate.

In the latter measure, if the adhered drops of water are once introduced in the gas sensor element through the water shedding film and the porous protection layer, the tensile stress caused by the introduced drops of water may cause the gas sensor element to deteriorate, which is similar to the former measure.

In either the former measure or the latter measure, the porous protection layer and/or the water-shedding film is formed on the substantially whole surface of the gas sensor element, which may increase the heat capacity of the gas sensor element. This increase of the heat capacity of the gas sensor element may cause an adverse effect on the early activation of the gas sensor element and the delay in the controlling the gas sensor element.

### SUMMARY OF THE INVENTION

The present invention is made on the background.

Accordingly, it is an object of the present invention to provide a gas sensor element and a method of manufacturing the same, which are capable of having a high reliability against water cracks and a higher early activation.

According to one aspect of the present invention, there is provided a gas sensor element for measuring a concentration of a specified gas component contained in a target gas, the gas sensor comprising: a sensor portion having a solid electrolyte member and first and second electrodes, the solid electrolyte member having first and second surfaces opposite thereto, the first and second electrodes being mounted on the first and second surfaces of the solid electrolyte member, respectively; and a heater member having a heating element and one and other surfaces opposite thereto, the sensor portion being integrally laminated on the one surface of the heater member, the other surface of the heater member being contactable to the target gas, wherein at least a part of the other surface of the heater member has a ten points average roughness, the ten points average roughness being no more than 1.71 μm.

According to another aspect of the present invention, there is provided a method of manufacturing a gas sensor element for measuring a concentration of a specified gas component contained in a target gas, the method comprising: preparing a sensor portion, the sensor portion comprising a solid electrolyte member and first and second electrodes, the solid electrolyte member having first and second surfaces opposite thereto, the first and second electrodes being mounted on the first and second surfaces of the solid electrolyte member, respectively; preparing a heater member having a heating element and one and other surfaces opposite thereto; integrally laminating the sensor portion on the one surface of the heater member, the other surface of the heater member being contactable to the target gas; firing the integrally laminated sensor portion and heater member; cooling the fired sensor portion and heater member; and treating at least a part of the other surface of the heater member so that a ten points average roughness of the at least part of other surface of the heater member is no more than 1.71 μm.

According to further aspect of the present invention, there is provided a method of manufacturing a gas sensor element for measuring a concentration of a specified gas component contained in a target gas, the method comprising: preparing a sensor portion, the sensor portion comprising a solid electrolyte member and first and second electrodes, the solid electrolyte member having first and second surfaces opposite thereto, the first and second electrodes being mounted on the first and second surfaces of the solid electrolyte member, respectively; preparing a heater member having a heating element and one and other surfaces opposite thereto; preparing a base member having a mount surface, at least a part of the mount surface having a ten points average roughness, the ten points average roughness of the at least part of the mount surface being no more than approximately 8.55 μm; mounting the integrally laminated sensor portion and heater member on the mount surface of the base member so that the other surface of the heater member is contacted to the mount surface thereof; firing the integrally laminated sensor portion and heater member while the laminated sensor portion and heater member is mounted on the base member; cooling the fired sensor portion and heater member while the laminated sensor portion and heater member is mounted on the base member; and separating the sensor portion and heater from the base member.

According to still further aspect of the present invention, there is provided a method of manufacturing a gas sensor element for measuring a concentration of a specified gas component contained in a target gas, the method comprising: preparing a sensor portion, the sensor portion comprising a solid electrolyte member and first and second electrodes, the solid electrolyte member having first and second surfaces opposite thereto, the first and second electrodes being mounted on the first and second surfaces of the solid electrolyte member, respectively; preparing a heater member having a heating element and one and other surfaces opposite thereto; preparing a base member having a mount surface, at least a part of the mount surface having a ten points average roughness, the ten points average roughness of the at least part of the mount surface being more than approximately 8.55 μm; mounting the integrally laminated sensor portion and heater member on the mount surface of the base member so that the other surface of the heater member is contacted to the mount surface thereof; firing the integrally laminated sensor portion and heater member while the laminated sensor portion and heater member is mounted on the base member; cooling the fired sensor portion and heater member while the laminated sensor portion and heater member is mounted on the base member; separating the sensor portion and heater from the base member; and polishing the at least part of other surface of the heater member so that the ten points average roughness of the at least part of other surface of the heater member is no more than 1.71 μm.

### BRIEF DESCRIPTION OF THE DRAWINGS

Other objects and aspects of the invention will become apparent from the following description of an embodiment with reference to the accompanying drawings in which:

FIG. 1 is a typically exploded perspective view illustrating a laminated structure of a gas sensor element according to an embodiment of the present invention;

FIG. 2A is a perspective view illustrating the second surface side of the gas sensor element according to this embodiment shown in FIG. 1;

FIG. 2B is a perspective view illustrating the first surface side of the gas sensor element according to the embodiment shown in FIG. 1;

FIG. 3 is a flowchart illustrating processes of a first example of the manufacturing method of the gas sensor element shown in FIGS. 1, 2A and 2B;

FIG. 4 is a schematically perspective view illustrating a hexagon tank and a jig for polishing the gas sensor element according to the first embodiment;

FIG. 5 is a schematically perspective view illustrating a firing process according to the second example of the present invention;

FIG. 6 is a flowchart illustrating processes of a second example of the manufacturing method of the gas sensor element shown in FIGS. 1, 2A and 2B;

FIG. 7 is a view illustrating a relationship between the ten points average roughnesses and the crack incidence rates thereof according to the first and second examples;

FIG. 8 is an explanation view explaining a condition at which a water drop falls into a first target gas contact surface according to the first embodiment; and

FIG. 9 is an explanation view explaining a condition at which a water drop falls into a target gas contact surface of a conventional gas sensor element.

### DETAILED DESCRIPTION OF EMBODIMENTS OF THE INVENTION

An embodiment of the invention will be described hereinafter with reference to the accompanying drawings.

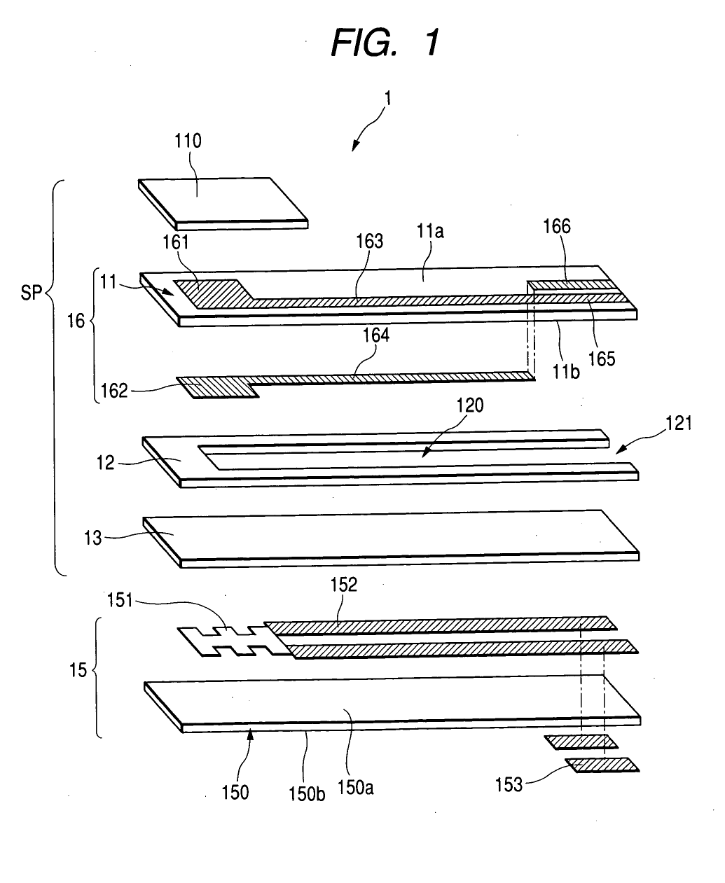

FIG. 1 is a typically exploded perspective view illustrating a laminated structure of a gas sensor element according to an embodiment of the present invention.

The gas sensor element 1, as shown in FIG. 1, is provided with a solid electrolyte plate 11 and having first and second surfaces 11a and 11b opposite to each other. The gas sensor element 1 is also provided with a target-gas side electrode 161 mounted on the first surface 11a of the solid electrolyte plate 11, and a reference electrode 162 mounted on the second surface 11b thereof. The target-side gas electrode 161 and the reference electrode 162 are opposite to each other.

The gas sensor element 1 is also provided with a reference gas chamber forming plate 12, an insulating plate 13, and a heater substrate 150 and having first and second surfaces 150a and 150b opposite to each other. The gas sensor element 1 is provided with a heating element 151 formed on the first surface 150a of the heater substrate 150. Energization of the heating element 151 allows it to generate heat.

The insulating plate 13 is mounted on the first surface 150a of the heater substrate 150, the reference gas chamber forming plate 12 is mounted on the insulating plate 13, and the solid electrolyte plate 11 is mounted on the reference gas chamber forming plate 12, respectively, which provide a laminated structure. That is, the plate members 11, 12, 13, and 150 are laminated and integrally fired, whereby the plate members 11, 12, 13, and 150 are combined with each other.

The solid electrolyte plate 11 and the reference gas chamber 12 constitute an electrochemical cell 16, and the insulating plate 13 and the heater plate 150 constitute a heater 15.

The target-gas side electrode 161 is disposed at one end portion of the first surface 11a of the solid electrolyte plate 11, and the reference electrode 162 is disposed at one end portion of the second surface 11b of the solid electrolyte plate 11. Lead electrodes 163 and 164 are formed on the first and second surfaces 11a and 11b of the solid electrolyte plate 11, respectively.

One end portions of the lead electrodes 163 and 164 are joined to the target-gas side electrode 161, and the lead electrodes 163 and 164 extend from the target-gas side electrode 161 and the reference electrode 162 in the longitudinal direction of the solid electrolyte plate 11 toward other end portion thereof, respectively. Other end portion 163 of the lead electrode 163 is served as a terminal 165. Other end portion of the lead electrode 164 is electrically conducted through a through hole (not shown) to a terminal 166 mounted on the other end portion of the first surface 11a in parallel to the terminal 165.

The gas sensor element 1 is also provided with a protection layer 110 mounted on the one end portion of the first surface 11a of the solid electrolyte plate 11 to cover the target-gas side electrode 161.

The reference gas chamber forming plate 12 has a substantially concave shape in its lateral cross section orthogonal to the lamination direction of the sensor element 1, forming a reference gas chamber 120 therein in the longitudinal direction of the plate 12.

One end portion of the reference gas chamber 120 is opposite to the reference electrode 162 so that the reference electrode 162 is exposed to the one end portion of the reference gas chamber 120. One end portion of the reference gas chamber forming plate 12 facing the other end portion 121 of the solid electrolyte plate 11 is opened to be communicated with the reference gas chamber 120, which permits external air to be introduced into the reference gas chamber 120.

That is, the structure of the reference gas chamber forming plate 12 allows the reference electrode 162 of the solid electrolyte plate 11 to be subjected to air introduced into the reference gas chamber 120 through the opened portion 121.

On the other hand, the heating element 151 is disposed at one end portion of the first surface 150a of the heater substrate 150. A pair of lead electrodes 152 is formed on the first surface 150a of the heater substrate 150. One end portions of the paired lead electrodes 152 are joined to the heating element 151. Other end portions of the paired lead electrodes 152 are electrically connected via through holes (not shown) to paired terminals 153 formed on the second surface 150b of the heater substrate to be opposite to the other end portions of the paired lead electrodes 152.

Incidentally, the protection layer 110, the electrochemical cell 16, reference chamber forming plate 12, and the insulating plate 13 constitute a sensor portion SP configured to sense a concentration of the oxygen contained in the target gas, so that the sensor portion SP is mounted on the heater 15.

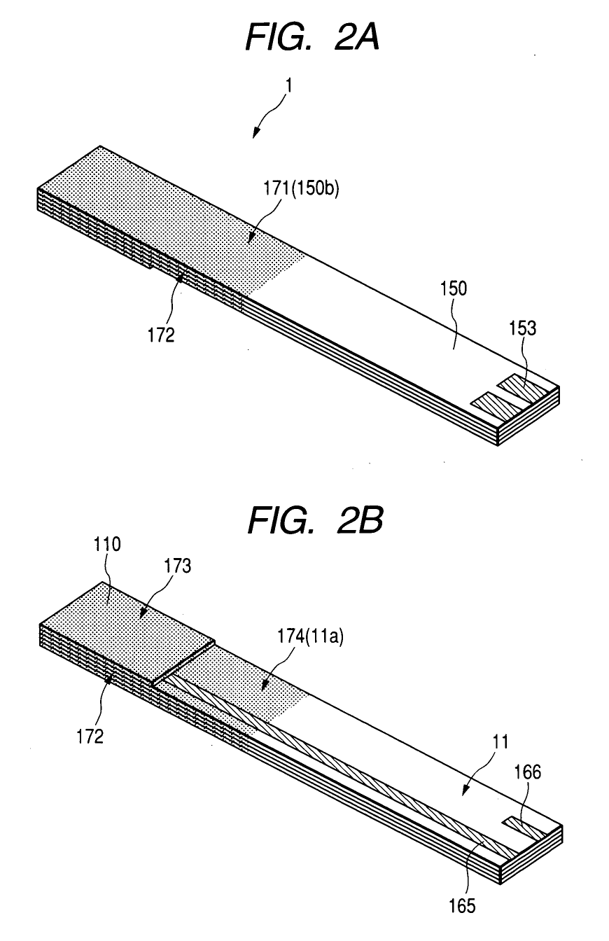

FIG. 2A is a perspective view illustrating the second surface side of the gas sensor element 1 according to this embodiment shown in FIG. 1, and FIG. 2B is a perspective view illustrating the first surface side of the gas sensor element 1 according to the embodiment shown in FIG. 1.

The gas sensor element 1, for example, is built in a gas sensor (not shown), and the gas sensor is employed in, for example, an automobile internal-combustion engine or other similar devices. The gas sensor is applied for measuring a concentration of a specified gas component, such as oxygen, or other similar gases contained in an exhaust gas exhausted from the automobile internal-combustion engine.

In particular, the gas sensor is disposed to the rare side of a catalyst disposed in the exhaust pipe, which is muffler of the engine.

Concretely, the gas sensor is disposed to one of the places susceptible to water in the muffler, such as the downstream side of the muffler through which the exhausted gas passing through the catalyst flows out. That is, the one end portion of the gas sensor element 1, on which the protection layer 110 is mounted, is subjected to the target gas, such as the exhaust gas.

The second surface 150b of the one end portion of the heater substrate 150 is a first target gas contact surface 171 of the one end portion of the gas sensor element 1, which is contacted to the target gas (exhaust gas). Moreover, the both side surfaces of the one end portion of the gas sensor element 1 are second target gas contact surfaces 172 of the one end portion of the gas sensor element 1, which is also contacted to the target gas.

In addition, an outer surface of the protection layer 110, which is opposite to the solid electrolyte plate side of the gas sensor element 1, is a third target gas contact surface 173 of the one end portion of the gas sensor element 1, which is contacted to the target gas. Moreover, the first surface 11a of the one end portion of the solid electrolyte plate 11 is a fourth target gas contact surface 174 of the one end portion of the gas sensor element 1, which is contacted to the target gas.

In this embodiment, all external surfaces of the gas sensor element 1 including the first to fourth target gas contact surfaces 171 to 174 are polished so that each ten points average roughness, which is determined by JIS B 0601, of each of all of the external surfaces of the gas sensor element 1 is not more than approximately 1.71 μm.

In the gas sensor element 1 according to this embodiment, the target gas is introduced through the protection layer 110 to the target gas electrode 161 of the sensor portion SP. On the other hand, the reference gas, such as air, is introduced into the reference gas chamber 120.

When the solid electrolyte plate 11 is heated through the insulating plate 13 and the reference gas chamber forming plate 12 (reference gas) by the heater 15, so that oxygen contained in the target gas are transferred from the target gas electrode 161, as oxygen ions, through the solid electrolyte plate 11 to the reference electrode 162. The transfer of the oxygen ions from the electrode 161 to the electrode 162 is represented as voltage between the electrodes 161 and 162, so that, detecting the voltage between the electrodes 161 and 162 allows the concentration of the oxygen contained in the target gas to be measured.

Next, concrete examples of the manufacturing method of the above structured gas sensor element 1 will be explained.

### First Example

As a first example of the manufacturing method of the above gas sensor element 1, at first, an example of forming a raw sheet for the solid electrolyte plate 11 is explained.

Partially 100 parts by weight yttria-stabilized zirconia made of 6 mole percent yttria and 94 mol percent zirconia is prepared. Each particle diameter of the 100 parts partially yttria-stabilized zirconia is approximately 0.5 μm.

1 parts by weight α-alumina, 5 parts by weight polyvinyl butyral, 10 parts by weight dibutyl phthalate, 10 parts by weight ethanolamine, and 10 parts by weight toluene are also prepared, respectively.

Then, the prepared partially 100 parts by weight yttria-stabilized zirconia, the 1 parts by weight α-alumina, the 5 parts by weight polyvinyl butyral, the 10 parts by weight dibutyl phthalate, the 10 parts by weight ethanolamine, and the 10 parts by weight toluene are confected to prepare ceramic mixtures.

Next, the ceramic mixtures are mixed in a media agitation mill to be slurried. This slurry is formed into a predetermined raw sheet by the doctor blade method so that the dry thickness of the raw sheet is approximately 0.2 mm. The raw sheet is dried so that a dry raw sheet is obtained. The dry raw sheet is cut to a 5×70 mm rectangular shape, and the through holes for electrical conduction of the lead electrode 164 and the terminal 166 are formed through the rectangular shaped sheet, respectively.

Then, the target-gas side electrode 161, the reference electrode 162, the lead electrodes 163 and 164, the terminals 165 and 166 are formed by printing of platinum paste on first and second opposing surfaces of the rectangular shaped sheet at predetermined positions, respectively, thereby producing a raw sheet corresponding to the solid electrolyte plate 11. Incidentally, the platinum paste used by the printing contains 10 parts by weight material which is the same as that of the slurry.

Next, an example of forming a raw sheet for the reference gas chamber forming plate 12 is explained.

98 parts by weight α-alumina each particle diameter of which is approximately 0.3 μm, and partially 3 parts by weight yttria-stabilized zirconia made of 6 mole percent yttria and 94 mol percent zirconia are prepared, respectively. 10 parts by weight polyvinyl butyral, 10 parts by weight dibutyl phthalate, 30 parts by weight ethanolamine, and 30 parts by weight toluene are also prepared, respectively.

Then, the prepared 98 parts by weight α-alumina, the partially 3 parts by weight yttria-stabilized zirconia, the 10 parts by weight polyvinyl butyral, the 10 parts by weight dibutyl phthalate, the 30 parts by weight ethanolamine, and the 30 parts by weight toluene are confected to prepare ceramic mixtures.

Subsequently, the ceramic mixtures are mixed in a media agitation mill to be slurried. This slurry is formed into a predetermined raw sheet by the doctor blade method so that the dry thickness of the raw sheet is approximately 1.0 mm, which is five times as large as the dry thickness of the raw sheet corresponding to the solid electrolyte plate 11.

The raw sheet is dried so that a dry raw sheet is obtained. The dry raw sheet is cut to a 5×70 mm rectangular shape, and a 2×67 mm groove corresponding to the reference gas chamber 120 is formed through the rectangular shaped sheet, thereby producing a raw sheet having a substantially concave shape and corresponding to the reference gas chamber forming plate 12.

Next, a sheet for the insulating plate 13 is produced based on the same materials and the same processes of the raw sheet corresponding to the reference gas chamber forming plate 12. The size of the sheet corresponding to the insulating plate 13 is 5×70 mm, and the thickness of which is 1 mm.

Next, a sheet for the heater substrate 150 is produced based on the same materials and the same processes of the raw sheet corresponding to the reference gas chamber forming plate 12. The size of the sheet corresponding to the heater substrate 150 is 5×70 mm, and the thickness of which is 1 mm.

The through holes for electrical conduction of the lead electrode 152 and the terminals 163 are formed through the sheet for the heater substrate 150, respectively.

Then, screen printing portions corresponding to the heating element 151, the lead electrode 152, the terminals 153, and electrode 161, the reference electrode 162, the lead electrodes 163 and 164, the terminals 165 and 166 are formed by screen printing of platinum paste on first and second opposing surfaces of the sheet for the heater substrate 150 at predetermined positions, respectively. As a result, a raw sheet corresponding to the heater substrate 150 is produced. Incidentally, the platinum paste used by the screen printing contains 10 parts by weight material which is the same as that of the slurry.

Next, an example of forming a sheet for the protection layer 110 is explained.

Alumina particles whose particle diameter is larger than those of the materials of the sheet for the heater substrate 150 are mixed in a pot mill for a predetermined time.

Mixed solution, as organic solvent, in which the ethanolamine and the toluene are mixed, polyvinyl butyral as binder, and dibutyl phthalate as plasticizer are added to the mixture of the alumina so that they are slurried.

This slurry is formed into a predetermined non-firing alumina sheet by the doctor blade method so that the thickness of the non-firing alumina sheet is approximately 0.2 mm.

The non-firing alumina sheet is cut to a 5×23 mm rectangular shape having a 0.12 mm in thickness, thereby producing a sheet corresponding to the protection layer 110.

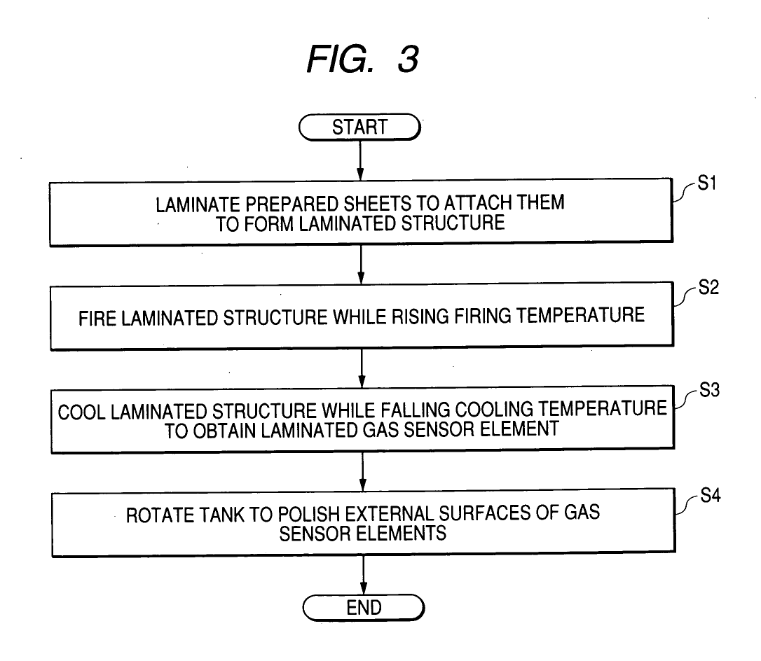

Next, the produced sheets, which correspond to the solid electrolyte plate 11, the reference gas chamber forming plate 12, the insulating plate 13, the heater substrate 150, and the protection layer 110, are laminated in the order represented by FIG. 1 to be attached to each other by pressure, thereby forming a laminated structure (in Step S1 of FIG. 3).

The laminated structure is fired within the range 1300° C. to 1600° C. in 2 hours while rising the firing temperature at the rate of 150° C. per hours (in Step S2 of FIG. 3).

After the firing process, the fired laminated structure is cooled up to its temperature is approximately equal to a room temperature while falling the cooling temperature at the rate of 150° C. per hours, thereby obtaining the laminated gas sensor element 1 (in Step S3 of FIG. 3).

Next, process of treating each ten points average roughness Rz of each of all of the external surfaces of the gas sensor element 1 to 1.71 μm or below will be explained hereinafter.

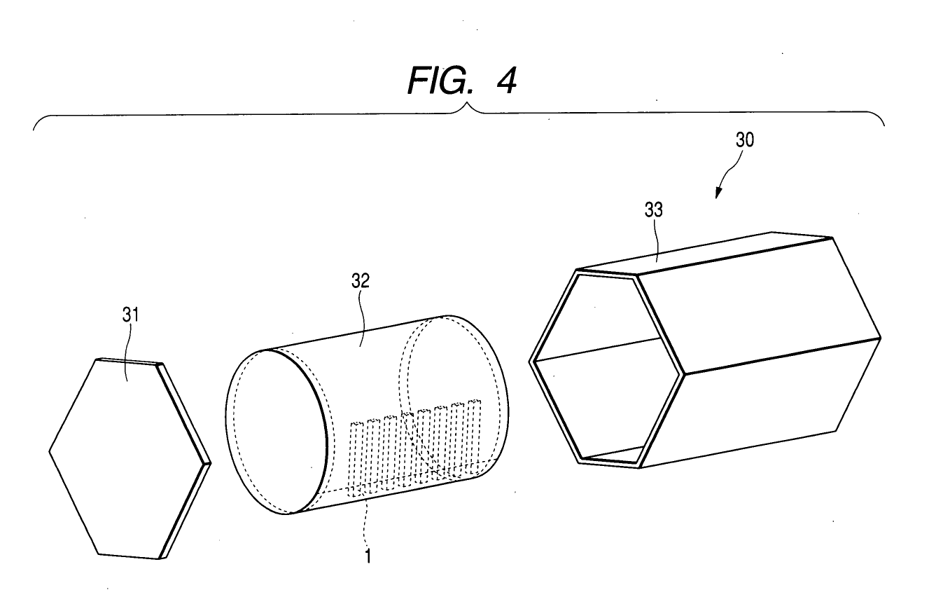

A plurality of the gas sensor elements 1 are prepared based on the above method, and the gas sensor elements 1 are set in an inner hollow cylindrical jig 32 (see FIG. 4). The jig 32 is fixed in an inner hollow hexagon tank body 33 of a tank 30, which has a substantially hexagon shape in its lateral cross section, of a barrel polishing apparatus,

Polishing agents having 50 volume percents, each of whose diameter is 1 mm, compounds of 30 cm³, additives of 60 g, and water of 2 L are supplied through an opened end portion of the tank body 33 into the inner hollow portion thereof (cylindrical jig 32), and a cap member 31 of the tank 30 is attached to the opened end portion of the tank body 33.

Then, the tank 30 (tank body 33), in which the jig 32 including the gas sensor elements 1 is set and to which the cap member 31 is attached, is normally rotated around its center axis by the barrel polishing apparatus at 200 rpm in 30 minutes, and reversely rotated thereby at 200 rpm in 30 minutes, whereby all external surfaces of each of the gas sensor elements 1 are wet polished by the polishing agents and the like in the tank body 33, respectively (in Step S4 of FIG. 3)

As a result, all external surfaces of each of the gas sensor elements 1 including the target gas contact surfaces 171-174 are treated so that the ten points average roughness of each of all of the external surfaces of each gas sensor element 1 is not more than approximately 1.71 μm. Incidentally, in cases of polishing only target gas contact surfaces 171-174 of each gas sensor element 1, the external surfaces of each gas sensor element 1 except for the target gas contact surfaces 171-174 are covered with resin cap members, and, after that, the gas sensor elements 1 are set in the jig 32. After the setting process, the above barrel polishing process is carried out.

### Second Example

In a second example of the manufacturing method of the above gas sensor element 1, as well as the first example, the non-firing sheets, which correspond to the solid electrolyte plate 11, the reference gas chamber forming plate 12, the insulating plate 13, the heater substrate 150, and the protection layer 110, are produced. The produced sheets are laminated in the order represented by FIG. 1 to be attached to each other by pressure, thereby forming a non-firing laminated structure 50, which is similar to the first example.

Then, it is noted that, when firing a non-firing ceramic sheet mounted on a mount surface of a base plate, the surface roughness Rz, which is determined by the JIS B 0601, of the mount surface of the base plate and that of a contact surface, which is contacted to the mount surface of the base plate, of the non-firing ceramic sheet have correlations therebetween.

As a result of experimentations concerning the above correlations, it was clear that, after the ceramic sheet mounted as its contact surface on the mount surface of the base plate is fired, the surface roughness of the contact surface of the ceramic sheet was approximately one-tenth to one fifth of the surface roughness of the mount surface of the base plate.

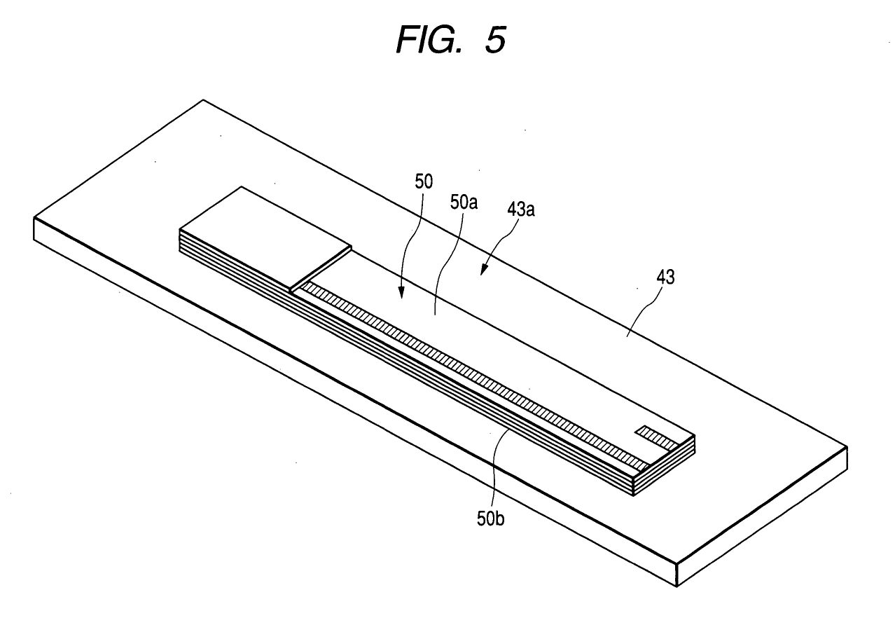

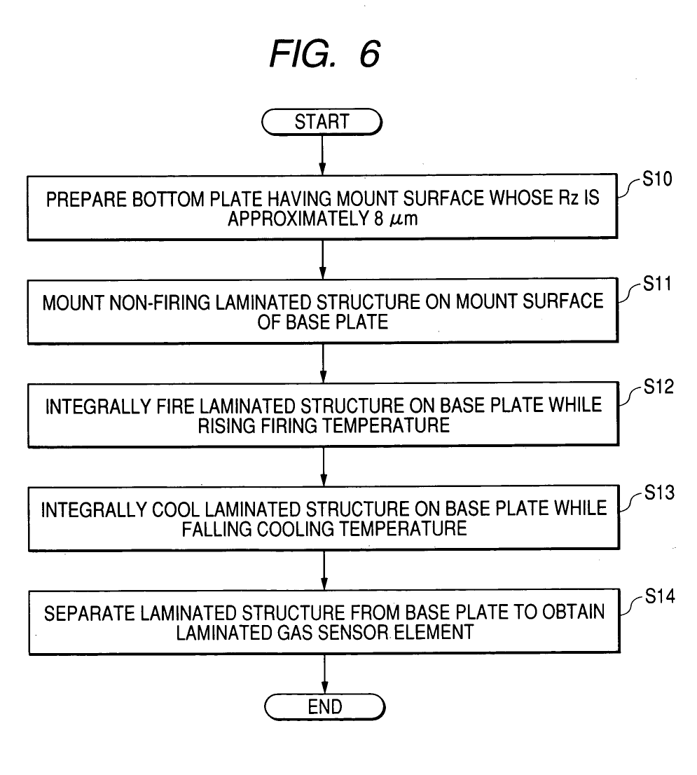

Then, as shown in FIG. 5, an alumina base plate 43 having one surface (mount surface) 43a whose ten points average roughness Rz is approximately 8 μm is prepared (in Step S10 of FIG. 6).

The above produced non-firing laminated structure 50 has a top surface 50a corresponding to, after firing, the fourth target gas contact surface 174 of the gas sensor element 1, and has a bottom surface 50b (contact surface) corresponding to, after firing, the first target gas contact surface 171 of the gas sensor element 1, so that the non-firing laminated structure 50 is mounted at the contact surface 50b on the mount surface 43a of the base plate 43 (in Step S11 of FIG. 6).

Then, similarly, to the first example, the laminated structure 50 mounted on the base plate 43 is integrally fired within the range 1300° C. to 1600° C. in 2 hours while rising the firing temperature at the rate of 150° C. per hours (in Step S12 of FIG. 6).

After the firing process, the fired laminated structure 50 mounted on the base plate 43 is integrally cooled up to its temperature is approximately equal to a room temperature while falling the cooling temperature at the rate of 150° C. per hours (in Step S13 of FIG. 6).

After the cooling process, the laminated structure 50 is separated from the base plate 43, so as to obtain the laminated gas sensor element 1 having the first target gas contact surface 171 whose ten points average roughness Rz is approximately not more than 1.71 μm (in Step S14 of FIG. 6).

Incidentally, firing the laminated structure 50 with whose all external surfaces mounted on the base plates and cooling them allows each of all of the external surfaces of the laminated structure 50 to have ten points average roughness Rz of 1.71 μm or below.

Next, performance evaluations of the gas sensor elements 1 each with the first target gas contact surface whose ten points average roughness is 1.71 μm or below, which are produced by one of the methods of the first and second examples, will be explained hereinafter as compared with gas sensor elements each with the first target gas contact surface whose ten points average roughness is more than 1.71 μm.

That is, as explained in the second embodiment, first and second types of base plates one type of those have the mount surfaces whose ten points average roughness are approximately 12 μm, and other type of those have the mount surfaces whose ten points average roughness is approximately 8 μm, are prepared, respectively. Incidentally, the known measurement apparatus, whose manufacture name “TOKYO SEIMITSU CO, LTD”, whose product name “SURFCOM”, whose model number “E-MD-S39A”, is used for measuring the ten points average roughness of each of the first and second types of base plates in accordance with the JIS B 0601.

Three gas sensor elements 1a1-1a3 were produced by using the second type of base plates each having the mount surface whose ten points average roughness is 8 μm in accordance with the method of the second example. Because of using the second type of base plates each having the mount surface whose ten points average roughness is 8 μm, ten points average roughnesses Rz of the first target gas contact surfaces 171 of the three gas sensor elements 1a1-1a3, which were measured by the above measurement apparatus, respectively, were not more than 1.71 μm, concretely, 1.27 μm without polishing the first target gas contact surfaces 171 (see the following table 1 hereinafter).

In addition, ten gas sensor elements 1a4-1a13 were produced by using the first type of base plates each having the mount surface whose ten points average roughness is 12.6 μm in accordance with the method of the second example. Next, the first target gas contact surfaces 171 of the three gas sensor elements 1a4-1a13 were polished based on the method of first example, and ten points average roughnesses Rz of the first target gas contact surfaces 171 of the ten gas sensor elements 1a4-1a13, which were measured by the above measurement apparatus, respectively, were not more than 1.71 μm, concretely, 1.71 μm (see the following table 1 hereinafter).

Furthermore, five gas sensor elements 1b1-1 b5 were produced by using the first type of base plates each having the mount surface whose ten points average roughness is 12.6 μm in accordance with the method of the second example. Because no polishing process is subjected to each of the first target gas contact surfaces 171 of the five gas sensor elements 1b1-1b5, the ten points average roughnesses Rz of the first target gas contact surfaces 171 of the five gas sensor elements 1b1-1b5, which were measured by the above measurement apparatus, respectively, were more than 1.71 μm, concretely, not less than 2.13 μm (see the following table 1 hereinafter).

TABLE 1

| | BOTTOM | | | |
|---|---|---|---|---|
| SENSOR | SURFACE'S | | | WATER |
| ELEMENT | Rz(μm) | POLISHING | Rz(μm) | CRACK |
| 1a4 | 12.6 | POLISHING | 1.71 | ◯ |
| 1a5 | | | 1.39 | ◯ |
| 1a6 | | | 1.49 | ◯ |
| 1a7 | | | 1.24 | ◯ |
| 1a8 | | | 1.22 | ◯ |
| 1a9 | | | 1.33 | ◯ |
| 1a10 | | | 1.28 | ◯ |
| 1a11 | | | 1.37 | ◯ |
| 1a12 | | | 1.19 | ◯ |
| 1a13 | | | 1.49 | ◯ |
| 1b1 | | NON-POLISHING | 2.24 | X |
| 1b2 | | | 2.13 | X |
| 1b3 | | | 3.66 | X |
| 1b4 | | | 2.26 | X |
| 1b5 | | | 2.31 | X |
| 1a1 | 8 | NON-POLISHING | 1.15 | ◯ |
| 1a2 | | | 1.25 | ◯ |
| 1a3 | | | 1.27 | ◯ |

As shown in table 1, even if the first type base plates whose mount surfaces have the ten points average roughnesses of 12.6 μm, after the laminated structures mounted on the base plates are fired, because the contact surfaces of the laminated structures are polished, the maximum of the ten points average roughnesses of the gas sensor elements 1a4-1a13 is only 1.71 μm.

In contrast, in cases of using the first type base plates whose mount surfaces have the ten points average roughnesses of 12.6 μm, after the laminated structures mounted on the base plates are fired, when no polishing operations are applied on the contact surfaces of the laminated structures, even the minimum of the ten points average roughnesses of the gas sensor elements 1b1-1b5 is 2.13 μm.

In addition, in cases of using the second type base plates whose mount surfaces have the ten points average roughnesses of 8 μm, after the laminated structures mounted on the base plates are fired, even if no polishing operations are applied on the contact surfaces of the laminated structures, the maximum of the ten points average roughnesses of the gas sensor elements 1a1-1a3 is only 1.27 μm.

Next, when putting the drops of water into each of the first target gas contact surfaces 171 of each of the gas sensor elements 1a1-1a13 and 1b1-1b5, whether cracks due to the drops of water occur in each of the first target gas contact surfaces 171 of each of the gas sensor elements 1a1-1a13 and 1b1-1b5 was measured.

In particular, each of the heating elements 151 was energized, and each of the gas sensor elements 1a1-1a13 and 1b1-1b5 was heated so that the temperature directly above each of the heating elements 151 was up to approximately 600° C. After the heating process, drops of water of, for example, 1 μL, was put into each of the first target gas contact surfaces 171 of each of the gas sensor elements 1a1-1a13 and 1b1-1b5, and after that, each of the gas sensor elements 1a1-1a13 and 1b1-1b5 was gradually cooled so that its temperature is approximately up to the room temperature. After cooling process, the gas sensor elements 1a1-1a13 and 1b1-1b5 were soaked in red stained fluids for one minute, and after that, washed with running water, respectively.

After the washing process, whether the red-stained fluids were seeped into the as sensor elements 1a1-1a13 and 1b1-1b5 were observed with the naked eye of an observer.

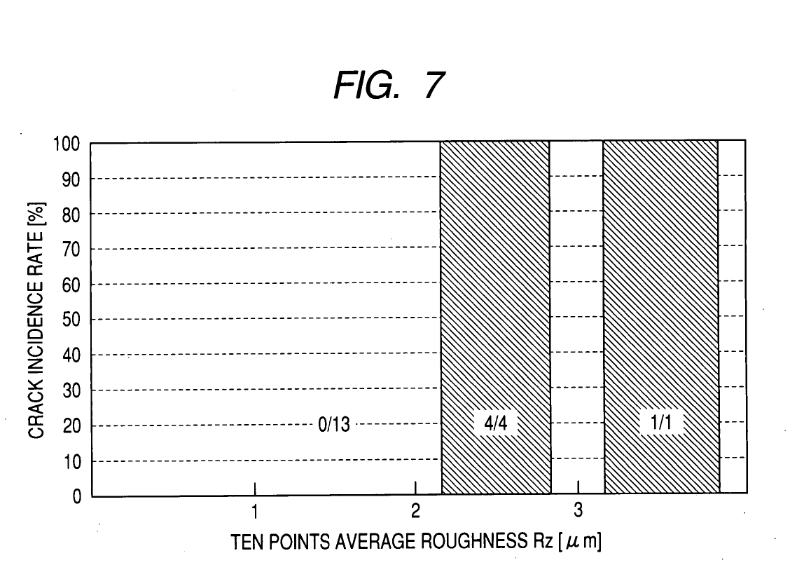

The result of the observation was shown in FIG. 7 and the table 1.

As shown in the table 1 and FIG. 7, no water cracks occur in the gas sensor elements 1a1-1a13 having the first target gas contact surfaces 171 whose ten points average roughnesses Rz are not more than 1.71 μm, that is, the water crack incidence rates (%) of the gas sensor elements 1a1-1a13 are zero, respectively.

In contrast, water cracks occur in the gas sensor elements 1b1-1b5 having the first target gas contact surfaces 171 whose ten points average roughnesses Rz are more than 1.71 μm, that is, the water crack incidence rates (%) of the gas sensor elements 1b1-1b5 are 100 (%).

As described above, because the at least first target gas contact surface 171 of the gas sensor element 1 has the small ten points average roughnesses Rz of 1.71 μm and below, the at least first target gas contact surface 171 is smooth, which allows the at least first target gas contact surface 171 to repel the drops of water, thereby deteriorating the wetting property of the at least first target gas contact surface 171 of the gas sensor element 1 against the water drops.

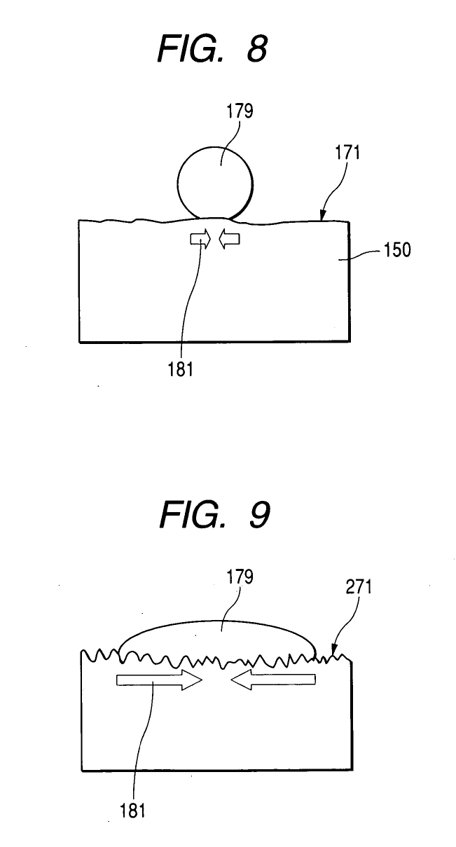

This results in that, as shown in FIG. 8, the water drop 179, which falls into the first target gas contact surface 171, is repelled by the first target gas contact surface 171 to be rounded, the contacting area of the first target gas contact surface 171 to the water drop 179 reduced.

The contacting portion of the target gas contact surface 171 to the water drop 179 is cooled to shrink, thereby causing tensile stress 181 around the contacting portion. However, in the gas sensor element 1, because the contacting area of the first target gas contact surface 171 to the water drop 179 is reduced, the tensile stress 181 is also reduce.

In contrast, as shown in FIG. 9, because the at least first target gas contact surface 271 of the gas sensor element 1 has the large ten points average roughnesses Rz of more than 1.71 μm, the surface tension of the at least first target gas contact surface 271 is reduced. This causes the water drop 179, which falls into the first target gas contact surface 271 and has equal amount of the water drop in FIG. 6, to be widely spread on the first target gas contact surface 271.

That is, the contacting area of the target gas contact surface 171 to the water drop 179 is wide so that tensile stress 181 around the contacting portion is increased, thereby increasing the probability of the crack incidence rate.

As described above, in this embodiment, the gas sensor element 1 has at least first target gas contact surface 171 whose ten points average roughness is not more than 1.71 μm, which improves the reliability against the water cracks of the gas sensor element 1, and can provide the gas sensor element 1 effective to early activation.

Incidentally, in the embodiment, the gas sensor element according to the present invention has one electrochemical cell (sensor portion 16) composed of the pair of target gas electrode 161 and the reference electrode 162, and the solid electrolyte plate 11, but the present invention is not limited to the structure. That is, the present invention may be applied to a gas sensor element having a plurality of electrochemical cells.

Incidentally, in the embodiment, the present invention is applied to the gas sensor element for measuring the concentration of the oxygen, but the present invention is not limited to the application. That is, the present invention may be applied to gas sensor elements which measure the concentrations of other gasses, such as NOx, HC, and CO.

In addition, the present invention may be applied to an element for measuring an air-fuel ratio of the engine based on the measured concentration of the oxygen.

The present invention may be applied to laminated gas sensor elements each of which has a heater and any measuring methods including a method of measuring the concentration of the oxygen to measure an electromagnetic force and a method of measuring a limiting current based on the diffusion of the oxygen.

The gas sensor element according to the present invention has high reliability against water cracks, so that the gas sensor element may be preferably used in an exhaust pipe of an internal combustion engine or other a similar device. More preferably, the gas sensor element may be used to be disposed at one of the places susceptible to water, such as the downstream side of the catalyst in the exhaust pipe of the engine.

Moreover, in the embodiment, all area of the first target gas contact surface 171 has the ten points average roughness Rz of not more than 1.71 μm, but a part of the first target gas contact surface 171 may have the ten points average roughness Rz of not more than 1.71 μm. Preferably, no less than 90% of all area of the first target gas contact surface 171 may have the en points average roughness Rz of not more than 1.71 μm.

In addition, in the first embodiment, the at least first target gas sensor element 171 has the ten points average roughness Rz of not more than 1.71 μm, but each of the first to fourth target gas contact surfaces 171 to 174 may have the ten points average roughness Rz of not more than 1.71 μm. In this structure, it is possible to prevent the first to fourth target gas contact surfaces 171 to 174 from causing water cracks.

Furthermore, each of all external surfaces including the surfaces 171 to 174 may have the ten points average roughness Rz of not more than 1.71 μm. In this structure, it is possible to prevent all of the external surfaces of the gas sensor element 1 from causing water cracks.

In addition, because the second surface 150b of the heater substrate 150 is easily to increase in temperature in all external surfaces of the sensor element 171, the water cracks are most apt to occur in the second surface 150b when the water drop is adhered thereon.

Therefore, when using gas sensor element 1 under such a condition that the external surfaces except for the first target gas contact surface are not much increased in temperature, controlling the ten points average roughness Rz of the only first target gas contact surface 171 allows improvement effects of the gas sensor element against the water cracks to be improved.

Moreover, in the second example, the ten points average roughness of the mount surface 43a of the base plate 43 is treated to be approximately 8 μm, but the present invention is not limited to the structure.

That is, because the surface roughness of the contact surface of the ceramic sheet is approximately one-tenth to one fifth of the surface roughness of the mount surface of the base plate, the ten points average roughness of the mount surface 43a of the base plate 43 is treated to be no more than approximately 8.55 μm, which is obtained by multiplying 1.71 μm by 5.

In addition, if the ten points average roughness of the mount surface 43a of the base plate 43 is treated to be more than approximately 8.55 μm, as described above, after the laminated structure 50 is separated from the base plate 43, the at least first target gas contact surface 171 can be polished so that the ten points average roughness Rz of the surface 171 can be no more than 1.71 μm.

While there has been described what is at present considered to be the embodiment and modifications of the invention, it will be understood that various modifications which are not described yet may be made therein, and it is intended to cover in the appended claims all such modifications as fall within the true spirit and scope of the invention.

This application is based upon and claims the benefit of priority of the prior Japanese Patent Application 2003-80884 filed on Mar. 24, 2003, and the prior Japanese Patent Application 2003-413763 filed on Dec. 11, 2003 so that the contents of which are incorporated herein by reference.

What is claimed is:

1. A gas sensor element for measuring a concentration of a specified gas component contained in a target gas, said gas sensor comprising:
a sensor portion having a solid electrolyte member and first and second electrodes, said solid electrolyte member having first and second surfaces opposite thereto, said first and second electrodes being mounted on the first and second surfaces of the solid electrolyte member, respectively; and
a heater member having a heating element and one and other surfaces opposite thereto, said sensor portion being integrally laminated on the one surface of the heater member, said other surface of the heater member being contactable to the target gas,
wherein at least a part of said other surface of the heater member has a ten points average roughness, said ten points average roughness being no more than 1.71 μm.

2. A gas sensor element according to claim 1, wherein said at least part of other surface of the heater member has an area, said area being no less than 90 percent of an all area of said other surface of the heater member.

3. A gas sensor element according to claim 1, further comprising:
a plurality of external surfaces including the other surface of the heater member, at least two of said external surfaces being contactable to the target gas, each of said at least two of external surfaces having a ten points average roughness, said ten points average roughness of each of the at least two of external surfaces being no more than 1.71 μm.

4. A gas sensor element according to claim 1, wherein said other surface of the heater member is a polished surface.

5. A method of manufacturing a gas sensor element for measuring a concentration of a specified gas component contained in a target gas, said method comprising:
preparing a sensor portion, said sensor portion comprising a solid electrolyte member and first and second electrodes, said solid electrolyte member having first and second surfaces opposite thereto, said first and second electrodes being mounted on the first and second surfaces of the solid electrolyte member, respectively;
preparing a heater member having a heating element and one and other surfaces opposite thereto;
integrally laminating the sensor portion on the one surface of the heater member, said other surface of the heater member being contactable to the target gas;
firing the integrally laminated sensor portion and heater member;
cooling the fired sensor portion and heater member; and
treating at least a part of the other surface of the heater member so that a ten points average roughness of the at least part of other surface of the heater member is no more than 1.71 μm.

6. A method of manufacturing a gas sensor element according to claim 5, wherein said treating includes polishing the at least part of other surface of the heater member so that the ten points average roughness of the at least part of other surface of the heater member is no more than 1.71 μm.

7. A method of manufacturing a gas sensor element for measuring a concentration of a specified gas component contained in a target gas, said method comprising:
preparing a sensor portion, said sensor portion comprising a solid electrolyte member and first and second electrodes, said solid electrolyte member having first and second surfaces opposite thereto, said first and second electrodes being mounted on the first and second surfaces of the solid electrolyte member, respectively;
preparing a heater member having a heating element and one and other surfaces opposite thereto;
preparing a base member having a mount surface, at least a part of said mount surface having a ten points average roughness, said ten points average roughness of the at least part of the mount surface being no more than approximately 8.55 μm;
mounting the integrally laminated sensor portion and heater member on the mount surface of the base member so that the other surface of the heater member is contacted to the mount surface thereof;
firing the integrally laminated sensor portion and heater member while the laminated sensor portion and heater member is mounted on the base member;
cooling the fired sensor portion and heater member while the laminated sensor portion and heater member is mounted on the base member; and
separating the sensor portion and heater from the base member.

8. A method of manufacturing a gas sensor element for measuring a concentration of a specified gas component contained in a target gas, said method comprising:
preparing a sensor portion, said sensor portion comprising a solid electrolyte member and first and second electrodes, said solid electrolyte member having first and second surfaces opposite thereto, said first and second electrodes being mounted on the first and second surfaces of the solid electrolyte member, respectively;
preparing a heater member having a heating element and one and other surfaces opposite thereto;
preparing a base member having a mount surface, at least part of said mount surface having a ten points average roughness, said ten points average roughness of the at least part of the mount surface being more than approximately 8.55 μm;
mounting the integrally laminated sensor portion and heater member on the mount surface of the base member so that the other surface of the heater member is contacted to the mount surface thereof;
firing the integrally laminated sensor portion and heater member while the laminated sensor portion and heater member is mounted on the base member;
cooling the fired sensor portion and heater member while the laminated sensor portion and heater member is mounted on the base member;
separating the sensor portion and heater from the base member; and
polishing the at least part of other surface of the heater member so that the at least part of ten points average roughness of the other surface of the heater member is no more than 1.71 μm.
